(19) United States
(12) Patent Application Publication
(10) Pub. No.: US 2005/0049167 A1
(43) Pub. Date: Mar. 3, 2005

(54) Alkylglycol alkoxylates or alkyldiglycol alkoxylates, mixtures thereof with tensides and their use

(76) Inventors: Ralf Noerenberg, Ingelheim (DE); Gunter Oetter, Frankenthal (DE); Jurgen Tropsch, Romerberg (DE); Helmut Gumbel, Dannenfels (DE); Nicole Lichterfeld-Weber, Romerberg (DE); Hubertus Kroner, Neustadt (DE); Hans-Peter Seelmann-Eggebert, Limburgerhof (DE)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/500,889

(22) PCT Filed: Jan. 21, 2003
(86) PCT No.: PCT/EP03/00551

(30) Foreign Application Priority Data
Jan. 21, 2002 (DE) 102 02 007.8
Sep. 30, 2002 (DE) 102 45 886.3

(51) Int. Cl. C11D 17/00

(52) U.S. Cl. 510/421

(57) ABSTRACT

The invention relates to alkylglycol alkoxylates and alkyldiglycol alkoxylates that are obtainable by alkoxylating C₄₋₈ alkylglycols or diglycols with C₂₋₅ alkoxides up to an average alkoxylation degree of 1 to 8, based on the C₄₋₈alkylglycols or diglycols. The invention further relates to mixtures from C₂₋₅ alkoxylates of C₄₋₈ alkylgycols or -diglycols that have an average alkoxylation degree of 1 to 8 and tensides that have an interfacial tension of less than 45 mN/m at 20° C. when dissolved in an amount of 5 g/l of water, and/or to diyhdroxyalkins or derivatives thereof.

The present invention relates to alkylglycol alkoxylates or alkyldiglycol alkoxylates, mixtures of alkylglycol alkoxylates or alkyldiglycol alkoxylates with each other and with surfactants, to compositions and formulations comprising these and to the use of such alkylglycol alkoxylates or alkyldiglycol alkoxylates in aqueous formulations or spray applications, preferably in surfactant-containing formulations which can also comprise dispersions or emulsions, e.g. coating compositions, cosmetic formulations and agrochemical formulations.

The rapid wetting of surfaces plays a central role in many areas of daily life and in many industrial processes, for example during the cleaning or coating of substrates. In many formulations, therefore, varying amounts of alcohol such as ethanol or isopropanol are used in order, for example, to lower the surface tension and thus to improve the wetting ability of the formulations. In this connection, it is customary to add often relatively large amounts of these alcohols to aqueous formulations. However, the physiological effect of the alcohols is unacceptable, and exposure for the user to such formulations is high as a result of the high vapor pressure of the alcohols. In addition, the properties of the alcohol as solvent especially in the case of plastic-containing surfaces lead to sometimes irreparable surface damage by partially dissolving the surfaces. Longer-chain alcohols, such as octyl alcohol or decyl alcohol, cannot completely overcome the physiological problems associated with their use either. For this reason, only small amounts of alcohols or no alcohol should nowadays be present, for example, in surfactant formulations which are handled directly by the user. However, for very rapidly wetting formulations, such as humectants in the printing industry or additives for coating formulations, for example for paper finishing by a paper coating, they continue to be a necessary constituent.

For some years the very good wetting action of very hydrophobic, compact alcohols, which can be prepared from acetylene and aldehydes, has been known. These are, in particular, dihydroxyalkynes. However, these products are not compatible with all cleaner formulations and can often only be used using solubilizers such as cumene sulfonate. In this connection, it is often necessary to use a relatively large amount of the solubilizer compared with the wetting auxiliary, resulting in high secondary costs due to the use of the dihydroxyalkynes. In addition, the effect of the wetting auxiliary is impaired upon mixing with relatively large amounts of solubilizers.

A customary method of increasing the wetting rate of aqueous formulations consists in using surfactants which position themselves on interfaces and thus lower the interfacial tension. While, by adding alcohols such as ethanol or isopropanol to aqueous formulations, the resulting water/solvent mixture has a lower surface tension compared to water and thus exhibits improved wetting behavior, the wetting or surface coating in the case of the use of surfactant systems is dependent on time. The surfactant molecules must firstly diffuse at the surface and form an interfacial film there, as a result of which the interfacial tension or the surface tension in the case of the contacting of water and air decreases. In the case of very rapid processes, such as, for example, spraying or wetting processes, for example fountain solutions in the printing industry, the time in which the surface or interfacial tension is reduced to the equilibrium value by the surfactant system is decisive. The dynamics of the surfactant system is of great importance here for the wetting rate.

One application according to the invention is described, for example, by reference to a spray coating process. Such a spray coating process can, for example, be used in the production of coated paper with a dispersion.

In spray coating, the coating composition is atomized using pressure in a special nozzle to give fine droplets and sprayed onto the base paper. This mainly results in a uniform drop formation. The smaller the drops, generally the more uniform the applied layer since coverage of the surface with drops is more compact for a given coating weight. Between application and the subsequent drying step, the applied layer of drops should also level and even out.

Thus, spray coating and curtain coating mainly results in low surface tensions of the coating compositions. At the same time, the coating compositions should foam only slightly or not at all and have a minimal air content. Since paper finishing is a rapid production process (in practice coating speeds of up to 2000 m/min are achieved, newer pilot plants even permit speeds in excess of 3000 m/min), particular requirements are placed on the dynamic behavior of the coating compositions.

Other applications of a spraying process are found in the production of aerosols in medicinal or technical sectors or in painting in the domestic and commercial sector or in the application of crop protection formulations.

The coating of the interface by surfactant molecules takes place partially by free molecules (monomers) and by the breaking of aggregates and subsequent adsorption, meaning the exchange rate of the surfactant between solution and micelle is decisive. It is known that solubilizers such as cumene sulfonate impair aggregation of the surfactant in solution and therefore reduce solubility. As a result, hydrophobic wetting agents can be formulated at increased concentrations. However, the effect of the wetting agent in the formulation, which in most cases is used in dilute form, is reduced as a result. The solubilizers are in themselves not active at the interface. However, there are also amphiphilic structures, referred to as solubilizers, which solubilize hydrophobic molecules in the form of micelles. Interaction with the surfactants is nonspecific and indirect. For this reason, solubilizers do not enter directly into the process of interface coating either.

Low molecular weight alcohols with low degrees of ethoxylation, such as butyl diglycol and hexyl glycol, are known as nonaqueous solvents and are used in conjunction with surfactants in formulations. However, like the alcohols, these compounds are not physiologically acceptable, and their performance is not comparable with the performance of the dihydroxyalkynes or alcohols.

In addition, alcohol ethoxylates of lower alcohols are currently used as suitable wetting agents. However, as a result of the preparation, such products often contain amounts of alcohol, which again contribute decisively to the rapid wetting and, in cases of very short wetting times, may be the sole wetting component.

WO 95/27034 describes, for example, detergent compositions in the form of an oil-in-water microemulsion. They comprise a short-chain ethoxylated nonionic surfactant which has a short alkyl chain length. The ethoxylated nonionic surfactants are obtained by ethoxylation of short-chain alcohols. The specification is one example of publications which describe alcohol ethoxylates.

The use of ethoxylated alkanols in cleaners is also described in EP-A 0 620 270. The cleaner compositions described therein, however, do not comprise surfactants, but one polar solvent and one nonpolar or weakly polar solvent. The alkylene glycol alkyl ethers used therein should have an affinity both for the polar solvent and also for the nonpolar solvent and thus serve as solubility promoters.

The use of alkoxylates of shorter-chain alcohols as low-foam wetting agents is also described in EP-A 0 681 865. They are used here in combination with propylene oxide-modified shorter-chain alkanols. They can be used, in particular, in textile precursors.

U.S. Pat. No. 5,340,495 describes compositions which can be used for removing printing ink in printing machines. The cleaning liquids comprise, for example, a main fraction of a soybean oil methyl ester and smaller amounts of ethoxylated hexanol. The ethoxylated C₄₋₁₀-alcohols, described in general form, which contain 2 to 10 mol of ethylene oxide per mole of alcohol, are described as solubility promoters and removers of printing ink.

It is an object of the present invention to improve the wetting behavior of known wetting agents or laundry detergents or cleaners. In such compositions, the aim is to reduce the interfacial tension and also to accelerate the establishment of the interfacial tension. The disadvantages of the known additives for laundry detergent, cleaners and wetting agents are to be avoided. The dynamics of known surfactant systems are to be improved or be achieved using toxicologically acceptable ingredients. In addition, the aim, for example in formulations such as paper coating dispersions for spray coating, is to reduce the particle size and the foaming, and to improve the printability of the resulting papers. In addition, the aim was to optimize the formulations in spray applications such that the particle size and the foaming are reduced. Examples thereof are paper coating compositions, paints, surface coatings, cleaners or cosmetic or medicinal sprays.

We have found that this object is achieved according to the invention by alkylglycol alkoxylates or alkyldiglycol alkoxylates obtainable by alkoxylation of C₄₋₈-alkylglycols or -diglycols with C₂₋₅-alkoxylates to an average degree of alkoxylation of from 1 to 8, based on the C₄₋₈-alkylglycols or -diglycols.

We have found that this object is also achieved according to the invention by the use of C₂₋₅-alkoxylates of C₄₋₈-alkylglycols or -diglycols which, on average, have a degree of alkoxylation of from 1 to 8, for reducing the interfacial tension, in particular in short times of, customarily, less than 1 second, and accelerating the establishment of the interfacial tension in aqueous surfactant formulations or aqueous dispersions.

We have found that this object is also achieved by the use of the C₂₋₅-alkoxylates of C₄₋₈-alkylglycols or -diglycols which, on average, have a degree of alkoxylation of from 1 to 8, as solubilizers which, in particular, do not have any negative effect, but a positive effect on the wetting ability of wetting auxiliaries even in dilute systems, and for increasing the solubility of wetting auxiliaries in aqueous formulations which comprise nonionic surfactants.

We have also found that C₂₋₅-alkoxylates of C₄₋₈-alkylglycols or -diglycols which, on average, have a degree of alkoxylation of from 1 to 8 can be used for lowering the viscosity of surfactant-containing formulations.

We have found that this object is also achieved by the use of C₂₋₅-alkoxylates of C₄₋₈-alkylglycols or -diglycols which, on average, have a degree of alkoxylation of from 1 to 8 for increasing the wetting rate in aqueous wetting agents.

We have found that this object is also achieved by the use of C₂₋₅-alkoxylates of C₄₋₈-alkylglycols or -diglycols which, on average, have a degree of alkoxylation of from 1 to 8 for reducing the particle size in formulations for spray applications.

According to the invention, it has been found that a synergistic effect arises when surfactants are used together with the alkoxylates according to the invention, in particular ethoxylates of lower alkylglycols or -diglycols, which ensures that the interfacial tension between the aqueous solution and air is reduced to the value of, for example, alcohol-containing formulations within a few fractions of a second. By combining the lower alkylglycol alkoxylates or alkyldiglycol alkoxylates which have a very weak interface affinity according to the invention with surfactants it is possible both to reduce the level of interfacial tension, and also to considerably increase the rate at which the level is reached.

This synergistic effect arises particularly in the case of mixtures of C₂₋₅-alkoxylates, preferably of C₂₋₄-alkoxylates of C₄₋₈-alkylglycols or -diglycols which, on average, have a degree of alkoxylation of from 1 to 8, and surfactants which, dissolved in an amount of 5 μl of water, exhibit an interfacial tension of less than 45 mN/m at 20° C. and/or dihydroxyalkynes or derivatives thereof. The invention thus also relates to these mixtures.

The mixtures according to the invention can thus replace a large number of known formulations, for example alcohol-containing formulations.

The statements below refer just as much to alkyldiglycols as to alkylglycols or alkoxylates thereof.

The mixtures according to the invention comprise, as one component, C₂₋₅-alkoxylates, i.e. alkoxylates with C₂₋₅-alkoxides, of C₄₋₈-alkylglycols which, on average, have a degree of alkoxylation of from 1 to 8. The alkylglycols may be linear or branched alkylglycols. The binding of the C₄₋₈-alkyl radical to the glycol may be terminal or at any other position along the alkyl chain. Preference is given to linear alkylglycols, in particular to linear, terminal alkylglycols. The alkyl radicals of the alkylglycols preferably have 4 to 6 carbon atoms. The degree of alkoxylation is, on average, 1 to 8, preferably 2 to 6. For the alkoxylation, preference is given to using C₂₋₄-alkoxides. Preference is given to using ethylene oxide, propylene oxide, butylene oxide or mixtures thereof. Particular preference is given to using ethylene oxide. The preferred ranges are also based on the alkylglycol alkoxylates and alkyldiglycol alkoxylates per se.

The preparation takes place starting from alcohol-free, preferably pure alkylglycols and alkyldiglycols and not, as otherwise customary, starting from alkanols, by alkoxylation. The product mixtures therefore do not comprise any residual alkanols, but at most alkylglycols. A distribution of the alkoxylation degree specific for alkylglycols results. As a result of the preparation process, the alkylglycol alkoxylates are free from alcohols.

Alkoxylates are oligomeric or polymeric reaction products with alkoxides. Because of the kinetics of polymerizations known to the person skilled in the art, a random distribution of homologs automatically results, the average value for which is usually quoted. The frequency distribution of the homologs includes the starting material particularly at low degrees of alkoxylation. Although the choice of catalyst can influence the distribution to a certain extent, nothing changes with regard to the principle of the distribution curve. Pure alkyloligoglycols can be prepared only by distillative or chromatographic processing and are therefore expensive. Furthermore, it has been found that the distribution of the homologues has a considerable influence on the aggregation behavior.

The alkoxylates described here have the homolog distribution important for the aggregation behavior and the other properties according to the invention, without containing alcohol.

The distribution of the degrees of alkoxylation can be determined by chromatographic processes.

The table below shows the distribution curves for a customary n-hexanol ethoxylate (+3 EO), derived from n-hexanol, and an n-hexylglycol ethoxylate (+2 EO), derived from n-hexylglycol, side by side. The first column gives the amount of ethylene oxide (0-6) bonded to the n-hexyl radical (C6). On average, the two compounds contain the same amount of EO units.

| Area % | | |
|---|---|---|
| Chemistry | n-Hexanol + 3 EO | n-Hexylglycol + 2 EO |
| C6 E00 | 2.4 | 0 |
| C6 E01 | 5 | 8.3 |
| C6 E02 | 10.2 | 20.3 |
| C6 E03 | 13.5 | 24.6 |
| C6 E04 | 14.3 | 19.4 |
| C6 E05 | 13.5 | 12.9 |
| C6 E06 | 11.2 | 7.5 |
| Remainder | 29.9 | 7 |

The samples were prepared using KOH as catalyst by introducing 2 or 3 mol/(mol of starting material) of ethylene oxide into the starting material in question. Analysis is carried out by gel permeation chromatography (GPC) in THF. The hexanol signal was identified by spiking with hexanol, and the higher homologues from the sequence of the other signals. Evaluation was carried out by integration of the signal areas.

Since no alcohols are present in the product mixture according to the invention, it is substantially odor free. Surfactants which can be used according to the invention are all surfactants which, dissolved in an amount of 5 g/l of water, exhibit an interfacial tension of less than 45 mN/m at 20° C. The surfactants are generally alkoxylated alcohols, amides, acids, betaines, amine oxides or amine, but also dihydroxyalkynes and derivatives and mixtures thereof. The rate of the establishment of the ultimate level of the interfacial tension may depend here on the molecular architecture, such as the chain length and the degree of branching of the alcohol, the length and solvation of the alkoxylate, the surfactant concentration and surfactant aggregation. Generally, smaller aggregates diffuse more rapidly than large aggregates.

The surfactants are preferably nonionic surfactants and chosen from C₂₋₅-alkoxylates, preferably C₂₋₄-alkoxylates, of C₉₋₂₀-alkanols, preferably C₉₋₁₅-alkanols, in particular C₉₋₂₀-alkanols which, on average, have a degree of alkoxylation of from 3 to 30, preferably 4-15, in particular 5 to 12, and mixtures thereof. In particular, C₉₋₁₁-alkanols are used to construct the surfactants. In this connection, the alkanols may be linear or branched. In the case of a branched alcohol, the degree of branching is preferably in the range from 1.1 to 1.5. The alkoxylation can be carried out with any desired C₂₋₄-alkoxides and mixtures thereof. Alkoxylation can be carried out, for example, with ethylene oxide, propylene oxide or butylene oxide. Particular preference is given to using ethylene oxide, propylene oxide or mixtures thereof. Particular preference is given to ethylene oxide. The degree of alkoxylation is, on average, 3 to 8, preferably 3 to 6. Such nonionic surfactants are known and are described, for example, in EP-A 0 616 026 and EP-A 0 616 028. These specifications also mention shorter-chain alkyl alkoxylates.

The nonionic surfactants used as surfactants may also be replaced by dihydroxyalkynes or derivatives thereof. These may also be low-foam or foam-suppressing surfactants, cf. also EP-A 0 681 865 and the literature cited at the beginning. Low-foam and foam-suppressing surfactants are known to the person skilled in the art.

In the mixtures according to the invention, the alkylglycol alkoxylates are preferably used in an amount of from 0.05 or 0.1 to 20%, preferably 0.1 to 10% by weight, particularly preferably 0.5 to 7% by weight, especially 0.8 to 5% by weight, based on the total weight of the mixture. The remaining proportion of the mixtures is allotted to the surfactants. These amounts are also valid for the laundry detergents, cleaners, wetting agents, care compositions, crop protection compositions and cosmetic compositions or other compositions prepared from the mixtures or alkylglycol alkoxylates.

Laundry detergents or cleaners which may comprise a combination of the surfactants with alkanol alkoxylates are described, for example, in WO 01/32820. The compositions described therein additionally comprise solid particles with a particle size of from 5 to 500 nm. Such particles are usually not present in the mixtures according to the invention. The glycol ethers described in the WO application are described therein as hydrophilizing agents. The mixtures according to the invention can have the further ingredients described in WO 01/32820.

The present invention also relates to laundry detergents, cleaners or wetting agents which comprise a mixture or alkylglycol alkoxylate as described above. In addition, the invention relates to surface coatings, adhesives, leather-treatment compositions or textile-treatment compositions which comprise a mixture or alkylglycol alkoxylate or alkyldiglycol alkoxylates as described above. The mixtures according to the invention can be used with a formulation of compositions in all areas in which highly dynamic formulations are used. Examples thereof are
all-purpose cleaners, textile detergents, spray cleaners, hand dishwashing detergents for cleaning in the private, industrial and institutional sector including metal working,
humectants, printing roll and printing plate cleaners in the printing industry,
cosmetic, pharmaceutical and crop protection formulations,
paints, ink formulations, coating compositions, e.g. for paper, adhesives in the paints and polymer film industry,
formulations for spray applications, for example, in ink jets, paints, medicaments or cosmetics,
leather treatment, such as leather degreasing and leather greasing,
metal treatment, such as anticorrosion formulations, cutting, grinding or boring auxiliaries and lubricants,
formulations in the textile industry, such as leveling agents or formulations for yarn cleaning.
flotation auxiliaries and foaming auxiliaries.

Such formulations usually comprise further ingredients, such as surfactants, builders, fragrances and dyes, complexing agents, polymers and other ingredients. Typical formulations are described, for example, in WO 01/32820. Further ingredients suitable for different applications are described, by way of example, in EP-A 0 620 270, WO 95/27034, EP-A 0 681 865, EP-A 0 616 026, EP-A 0 616 028, DE-A 42 37 178 and U.S. Pat. No. 5,340,495.

In general, the mixtures according to the invention can be used in all sectors in which the action of interface-active substances is required.

Like the classical solubilizers, the ethoxylated lower alkylglycols used according to the invention increase the solubility, in particular of nonionic surfactants, and thus simultaneously provide for a clear solution of hydrophobic surfactants. Although a lowering of the interfacial tension of the solubilizers alone is also observed, this proved to be much lower than the effect of surfactants and alcohols.

As a result of the use of non-surface-active structures, the formulations according to the invention have better environmental and skin compatibility compared with systems described, for example, in EP-A 0 616 026. In contrast to common solubilizers, such as cumene sulfonates, interaction takes place specifically with the surfactants. The alkoxylated alkylglycols used according to the invention thus actively penetrate into the coating of the interface and accelerate the establishment of the interfacial equilibrium.

According to the invention, it is not necessary and not desired for a residual content of alcohol to be present in the mixtures or formulations according to the invention. According to one embodiment, the mixtures, compositions and formulations according to the invention are free from alcohol and preferably also from alkylglycols or diglycols, in particular from C₄₋₈-alkylglycols and C₉₋₁₃-alkanols. According to the invention it has been found that surfactant formulations with high interface dynamics can be formulated using the alkylglycol alkoxylates according to the invention without a residual content of alcohol which is usually present in lower alcohol alkoxylates in the product as a consequence of the preparation.

The wetting action according to the invention can be determined by a dynamic measurement of the interfacial tension, for example using a bubble pressure tensiometer. A suitable procedure is described, for example, in S. S. Dukhen, G. Kretzschmar, R. Miller (Ed.), Dynamics of adsorption at liquid interfaces, Elsevier, 1995. The wetting action on surfaces can be determined here by a dynamic measurement of the interfacial tension. Such a method is the video-aided, time-resolved contact angle measurement.

The invention further provides for the use of the alkyglycol alkoxylates, alkyldiglycol alkoxylates and mixtures thereof in surface finishing, e.g. paper finishing. The invention thus provides a coating composition which is an aqueous paper coating dispersion which comprises water, pigments, binders and 0.05 to 5% by weight, based on the pigments, of alkyglycol alkoxylates according to the invention or mixtures thereof. The formulations can comprise natural or synthetic binders or mixtures thereof. Further possible ingredients are rheology auxiliaries, dispersants, thickeners, etc.

In the coating compositions, the particle size can now be significantly influenced in the spray coating process, coupled with simultaneously low lack of foam of the coating compositions and good printability.

The pigments used in the coating compositions usually represent the main component. It is possible to use all customarily used pigments, such as calcium carbonates, kaolin, tallow, titanium dioxide, gypsum, chalk or synthetic pigments alone or in a mixture.

In addition, the coating compositions can comprise customary dispersants. Suitable dispersants are polyanions, for example, of oligo- or polyphosphoric acids or oligo or polyacrylic acids, which are usually used in amounts of from 0.01 to 3% by weight, based on the pigment used.

Suitable coating compositions usually comprise natural and/or synthetic binders, such as starch, polymer dispersions, such as, for example styrene/acrylate copolymers or styrene/acrylate/vinyl acetate copolymers (e.g. Acronale® from BASF AG) and/or styrene/butadiene copolymers (e.g. Styronal® from BASF AG) and/or tailored polymers which also contain other ethylenically unsaturated carbon compounds (e.g. Basonal®), which generally have a glass transition temperature of from −20° C. to +50° C.

The synthetic binders are preferably used in the form of an aqueous dispersion with a solids content of from 30 to 70%.

Further constituents of the coating compositions may be customary additives, such as cobinders, thickeners, such as, for example, modified starch, casein, polyvinyl alcohol, carboxymethylcellulose, synthetic thickeners based on acrylate and/or hardening agents, processing auxiliaries such as Ca stearate and/or neutralizing agents and/or optical brighteners. These additives are usually used alone or in a mixture in the coating composition in amounts of from 0 to 10% by weight, based on the pigment.

The alkylglycol alkoxylate or mixture is usually used in amounts of from 0.05 to 5%, based on the formulation, preferably in amounts of from 0.1 to 2%. In this connection, the alkylglycol alkoxylate or mixture can be added either during the preparation process of the coating composition directly (and/or) or else in a mixture with a constituent to the coating composition (e.g. a pigment slurry and/or a binder).

For the coating of paper surfaces, for example by means of spray coating, a coating composition is sprayed in the examples below using the process described in the Wochenblatt für Papierfabrikation, (2001), Special Issue “OptiSpray”—Coating and Sizing Conference Mar. 15, 2001 (published by the Deutscher Fachverlag GmbH, Frankfurt/Main).

The droplet sizes formed here can be measured using suitable analytical methods. This is preferably carried out in a test apparatus with only one spray nozzle. A suitable analytical method for determining droplet size distribution is the Fraunhofer diffraction.

The invention will be illustrated in more detail below by reference to examples:

### EXAMPLE 1

An aqueous solution of 2 g/l of a C₁₃-C₁₅-oxoalcohol ethoxylate with an average degree of ethoxylation of 7 (Lutensol® A07 from BASF AG) is analyzed using a bubble pressure tensiometer (model MPT 2 from Lauda). At equilibrium the interfacial tension is 42 mN/m, which is achieved after 0.7 s.

The addition of 1 g/l of cumene sulfonate influences neither the position nor the dynamics of the surfactant solution.

The addition of 1 μl of hexylglycol ethoxylate with an average degree of ethoxylation of 4 shifts the equilibrium value to 39 mN/m. The equilibrium value is achieved after just 0.4 s.

On the other hand, in a mixture of 1 g/l of the lauryl alcohol ethoxylate with an average degree of ethoxylation of 7 and 1 g/l of the hexylglycol ethoxylate in equilibrium, an interfacial tension of 42 mN/m is measured, which was reached after 0.7 s. The use of hexylglycol ethoxylate thus means that the amount of surfactant can be considerably reduced.

### EXAMPLE 2

A dihydroxyalkyne (Surfynol® 104H from Air Products) was analyzed in a typical fountain solution formulation in the printing industry. The fountain solution formulation comprises 150 g/l of glycerol, 770 g/l of water, 20 g/l of sodium dihydrogenphosphate, 40 g/l of succinic acid, 10 g/l of Surfynol 104H. In order to make the cloudy solution clear, 40 μl of cumene sulfonate (formulation A) or 20 g/l of hexylglycol ethoxylate with a degree of ethoxylation of 4 (formulation B) were added. The formulation was then diluted in the ratio 1:50, so that ultimately the content of dihydroxyalkyne was 0.2 g/l. The dynamic interfacial tension was measured using the bubble pressure tensiometer.

For the formulation A in equilibrium, an interfacial tension level of 50 mN/m is measured, which is reached after 0.5 s. For formulation B in equilibrium, a level of 43 mN/m is found, which is reached after 0.2 s.

From this it is clear that the formulation B according to the invention has advantages over comparative formulation A both in its static and also its dynamic properties.

Paper Finishing (Spray Coating)

Paper was coated in accordance with the process given above using the dispersions given in table 1.

The particle size during the coating was determined by Fraunhofer diffraction.

The particle distributions described in the table were achieved using an instrument from Malvern with a He—Ne laser, which represents a laser source with a wavelength of 633 nm. To record the measurement signals, use was made of a detector array with 31 elements, which can detect particle sizes from 6 to 560 μm. The evaluation software for the instrument gives, in addition to the particle size distribution, a characteristic mean value D50. Table 1 gives the measured mean value of the particle size distribution of the various formulations.

Papers which were coated with the coating compositions were smoothed at room temperature by pressing them through a calender four times. The nip pressure was 250 kN/m. The papers were then printed in a single color using a Prüfbau print test instrument, and the printing uniformity was determined using a “Tobias Tester”. This test method is described by Philipp E. Tobias et al in Tappi Journal Vol. 72, No. 5 (1989). The lower the Mottle Index values, the more uniform the printing image.

TABLE 1

| | Parts of binder | Parts of | | | |
|---|---|---|---|---|---|
| | (solid per 100 | HE per | | | |
| Parts of | parts of | 180 parts | SC | D50 | Mottle |
| pigment | pigment | of pigment | [%] | [μm] | Index |
| 100 carbonate | 12 Binder A | — | 52 | 42 | 190 |
| 100 carbonate | 12 Binder A | 1.0 | 52 | 27 | 172 |
| 100 carbonate | 12 Binder B | — | 52 | 43 | 206 |
| 100 carbonate | 12 Binder B | 1.0 | 52 | 29 | 178 |
| 100 carbonate | 12 Binder B | — | 55 | 40 | 213 |
| 100 carbonate | 12 Binder B | 1.0 | 55 | 28 | 182 |
| 100 carbonate | 12 Binder B | — | 60 | 38 | 216 |
| 100 carbonate | 12 Binder B | 1.0 | 60 | 27 | 185 |
| 100 carbonate | 12 Binder B | 0.6 | 55 | 30 | 184 |

Carbonate: Ca-carbonate with an average particle size of 800 mm
Binder A: Dispersion of styrene/acrylate copolymers with a glass transition temperature of 25° C.
Binder B: Dispersion of a carboxylated styrene/butadiene copolymer with a glass transition temperature of 25° C.
HE: Hexylglycol ethoxylate with a mean degree of ethoxylation of 4
SC: Solids content

1-14. (Cancelled).

15. An alkylglycol alkoxylate or alkyldiglycol alkoxylate that is free from alcohol obtained by the process comprising:
alkoxylating C₄₋₈-alkylglycols or -diglycols with C₂₋₅-alkoxides to an average degree of alkoxylation of from 1 to 8, based on the C₄₋₈-alkylglycols or -diglycols.

16. A mixture of C₂₋₅-alkoxylates of C₄₋₈-alkylglycols -or diglycols which, on average, have a degree of alkoxylation of from 1 to 8 as claimed in claim 15, and surfactants which, dissolved in an amount of 5 g/l of water, exhibit an interfacial tension of less than 45 mN/m at 20° C., and/or dihydroxyalkynes or derivatives thereof.

17. A mixture as claimed in claim 16, wherein the surfactants are nonionic surfactants and are chosen from C₂₋₅-alkoxylates of C₉₋₂₀-alkanols which, on average, have a degree of alkoxylation of from 3 to 30, and mixtures thereof.

18. A mixture as claimed in claim 16, wherein the surfactants are low-foam or foam-suppressing surfactants.

19. A laundry detergent, cleaner or wetting agent or cosmetic, pharmaceutical or crop protection formulation comprising a mixture as claimed in claim 16.

20. A mixture as claimed in claim 16, comprising 0.1 to 20% by weight of the C₂₋₅-alkoxylates of C₄₋₈-alkylglycols or -diglycols, based on the total weight of the mixture or of the composition.

21. A method of reducing the interfacial tension and accelerating the establishment of the interfacial tension in aqueous surfactant formulations or aqueous dispersions comprising:
contacting the aqueous surfactant formulations or aqueous dispersions with C₂₋₅-alkoxylates of C₄₋₈-alkylglycols or -diglycols which, on average, have a degree of alkoxylation of from 1 to 8, as claimed in claim 15.

22. A method of lowering the viscosity of surfactant-containing formulations comprising:
contacting these surfactant-containing formulations with C₂₋₅-alkoxylates of C₄₋₈-alkylglycols or -diglycols which, on average, have a degree of alkoxylation of from 1 to 8, as claimed in claim 15.

23. A laundry detergent, cleaner or wetting agent or cosmetic, pharmaceutical or crop protection formulation comprising a mixture as claimed in claim 17.

24. A laundry detergent, cleaner or wetting agent or cosmetic, pharmaceutical or crop protection formulation comprising a mixture as claimed in claim 18.

25. A laundry detergent, cleaner or wetting agent or cosmetic, pharmaceutical or crop protection formulation comprising alkylglycol alkoxylates or alkyldiglycol alkoxylates as claimed in claim 15.

26. A mixture as claimed in claim 17 comprising 0.1 to 20% by weight of the C₂₋₅-alkoxylates of C₄₋₈-alkylglycols or -diglycols, based on the total weight of the mixture.

27. A mixture as claimed in claim 18 comprising 0.1 to 20% by weight of the C₂₋₅-alkoxylates of C₄₋₈-alkylglycols or -diglycols, based on the total weight of the mixture.

28. A laundry detergent, cleaner or wetting agent or cosmetic, pharmaceutical or crop protection formulation as claimed in claim 19, comprising 0.1 to 20% by weight of the C₂₋₅-alkoxylates of C₄₋₈-alkylglycols or -diglycols, based on the total weight of the composition.
